(19) United States
(12) Patent Application Publication
(10) Pub. No.: US 2001/0029196 A1
(43) Pub. Date: Oct. 11, 2001

(54) Battery-powered mobile phone having additional functions

(76) Inventor: Kiichirou Wakamatsu, Anjo-city (JP)

Correspondence Address: FISH & RICHARDSON, PC, 4350 LA JOLLA VILLAGE DRIVE, SUITE 500, SAN DIEGO, CA, 92122, US

(21) Appl. No.: 09/827,820

(22) Filed: Apr. 6, 2001

(30) Foreign Application Priority Data
Apr. 7, 2000 (JP) 2000-106998

(51) Int. Cl. H04M 1/00

(52) U.S. Cl. 455/574; 455/127; 455/343

(57) ABSTRACT

A battery-powered mobile phone includes additional functions other than a communication function. Operation of the additional functions is restricted to save the battery capacity for the communication function when a residual battery capacity detected based on the terminal voltage decreases to a certain level. A warning indicating that the battery capacity has decreased to a certain level is given to a user when the additional functions are under operation. The user may terminate operation of the additional functions to save the battery capacity when the warning is given, or may choose to continue the operation. The communication function of the mobile phone can be kept longer by restricting operation of the additional functions in this manner.

### CROSS-REFERENCE TO RELATED APPLICATION

This application is based upon and claims benefit of priority of Japanese Patent Application No. 2000-106998 filed on Apr. 7, 2000, the content of which is incorporated herein by reference.

### BACKGROUND OF THE INVENTION

1. Field of the Invention

The present invention relates to a mobile phone powered by a battery and having a wireless communication function and other additional functions.

2. Description of Related Art

An example of a battery-powered mobile phone that includes a communication function and a digital camera function is disclosed in JP-A-10-304578. To avoid a situation where the communication function becomes inoperable due to battery power exhaustion by using the digital camera, operation of the digital camera is restricted based on a residual battery capacity. More particularly, when the battery capacity becomes lower than a level set by a user, the user is asked whether the user wants to operate the camera even if the residual battery capacity is low. If the user wants to operate the camera under such a situation, the user is allowed to do so by resetting the level of the residual battery capacity to a level lower than the level initially set. This inquiry is made to the user, irrespective of whether the user is actually using the camera or not, when the residual battery capacity becomes lower than the initially set level.

There are following problems in the mobile phone disclosed therein. The inquiry as to whether the user wants to operate the camera is made whenever the battery capacity becomes lower than the preset level, even if the user is not actually using the camera function and does not want to receive such an inquiry. Further, if the user wants to use the camera function after the inquiry is made, the user is required to reset the level of the residual battery capacity. Such resetting may be required more than one time while the camera is being operated. This is troublesome for the user. Moreover, the inquiry is displayed on a display panel and no sound signals are given. If a sound-related function such as a music function is included in the mobile phone as an additional function to a communication function, the visual display of the inquiry is not convenient for the user.

### SUMMARY OF THE INVENTION

The present invention has been made in view of the above-mentioned problems, and an object of the present invention is to provide an improved mobile phone in which a residual battery capacity is adequately controlled in a user-friendly manner.

A mobile phone having additional functions such as a music function or a television function in addition to a telephone communication function is powered by a battery contained in the mobile phone. A battery capacity is detected by monitoring a terminal voltage of the battery. When a residual battery capacity becomes lower than a first predetermined level, a warning is given to a user if the additional function is being operated. This warning is displayed on a display panel of the mobile phone. When the additional function is a music function, the warning is superposed on music sounds as warning sounds.

When the warning is given, the user may terminate operation of the additional function to save the battery capacity, or the user may continue the operation of the additional function if he/she so desires. When the battery capacity further decreases to a second predetermined level which is lower than the first level, power supply to the mobile phone may be cutoff.

In this manner, operation of the additional function is restricted when the battery capacity becomes lower than a certain level to keep the communication function operable for a longer time. The warning indicating the battery capacity is not sufficiently high is given to the user when the additional function is under operation. Therefore, the user is not bothered by unnecessary warnings. The additional function may be continued to be operated if the user so desires even after the warning is given. In the case where the additional function is a music function, the warning is given to the user as warning sounds superposed on the music sounds being played. In this manner the warning is effectively given to the user without fail.

According to the present invention, the communication function of the mobile phone having the additional function can be kept operable for a longer time by restricting operation of the additional function in a user-friendly manner.

Other objects and features of the present invention will become more readily apparent from a better understanding of the preferred embodiment described below with reference to the following drawings.

### BRIEF DESCRIPTION OF THE DRAWINGS

FIG. 1 is a plan view showing a mobile phone;

FIG. 2 is a block diagram showing circuitry in the mobile phone having a communication function and a music function as an additional function;

FIG. 3 is a flowchart showing a process for processing the music function;

FIG. 4 is a flowchart showing a process for monitoring a battery voltage as a comparative example;

FIGS. 5A and 5B show a flowchart illustrating a process for monitoring the battery voltage as an embodiment of the present invention; and

FIG. 6 is a graph explaining an advantage of the present invention.

### DETAILED DESCRIPTION OF THE PREFERRED EMBODIMENT

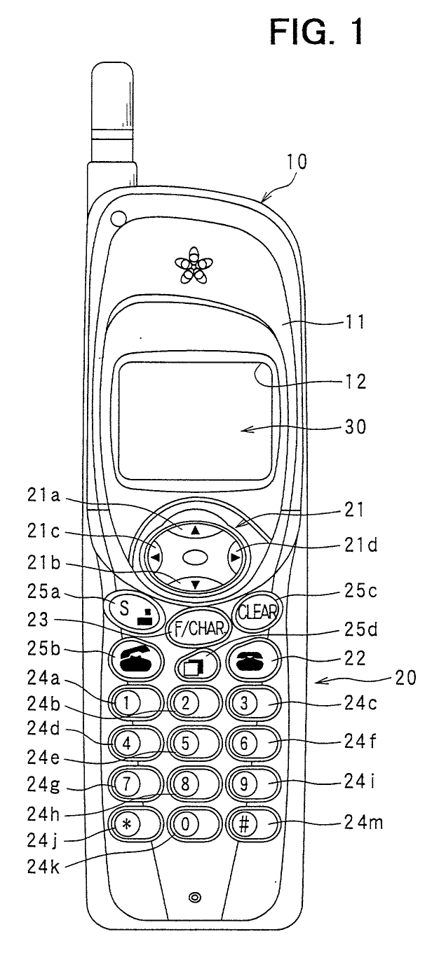

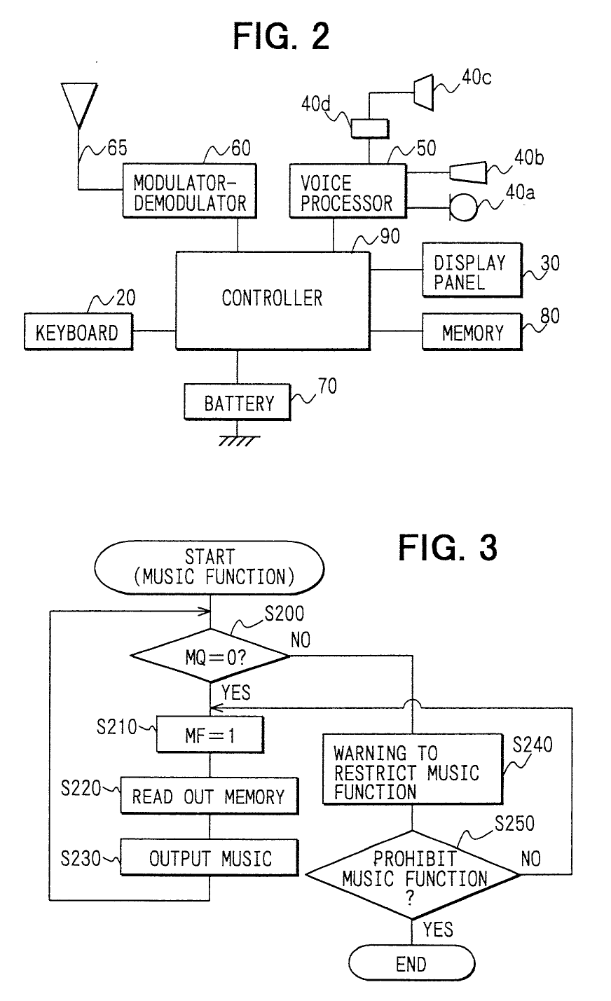

The structure and the function of the mobile phone to which the present invention is applied will be briefly described with reference to FIGS. 1 and 2. First, referring to FIG. 1 which shows a plan view of the mobile phone, its structure will be briefly described. The mobile phone is mainly composed of a casing 10, a keyboard 20 and a display panel 30. The keyboard 20 is disposed in a front case 11 and includes a cross-key 21 having directional arrows 21a-21d, a power key 22, a function key 23, ten-keys consisting of 24a-24k and 24m, and other keys 25a-25d. The display panel 30 is disposed in an opening 12 formed on the front case 11 and visually displays various information thereon.

Referring to FIG. 2, the electrical circuitry in the mobile phone will be briefly explained. The mobile phone includes a microphone 40a, a receiver 40b, an earphone 40c, an earphone terminal 40d, a voice processor 50, a modulator-demodulator 60, an antenna 65, a rechargeable battery 70, a memory 80 and a controller 90. The microphone converts user's voices into transmitting voice signals and outputs the signals to the voice processor 50. The receiver 40b generates voice sounds and music sounds based on signals fed from the voice processor 50. The voice processor 50 controlled by the controller 90 converts demodulated signals fed from the modulator-demodulator 60 to voice signals and outputs the voice signals to the earphone 40c or the receiver 40b. Also, the voice processor 50 converts voice signals fed from the microphone 40a to transmitting signals and outputs the signals to the modulator-demodulator 60. The voice processor 50 also outputs music sounds to the earphone 40c or the receiver 40b under control of the controller 90.

The modulator-demodulator 60 demodulates signals received through the antenna 65 and outputs the demodulated signals to the voice processor 50, while it modulates transmitting signals fed from the voice processor 50 and outputs the modulated signals to the antenna 65. The rechargeable battery 70 supplies power to the voice processor 50, the modulator-demodulator 60, the memory 80 and the controller 90. The memory 80 stores a computer program for the controller 90 and music data delivered through an internet. The memory 80 also stores therein a flag MF for indicating that the music function is being operated and a flag MQ indicating that the music function is allowed to be operated.

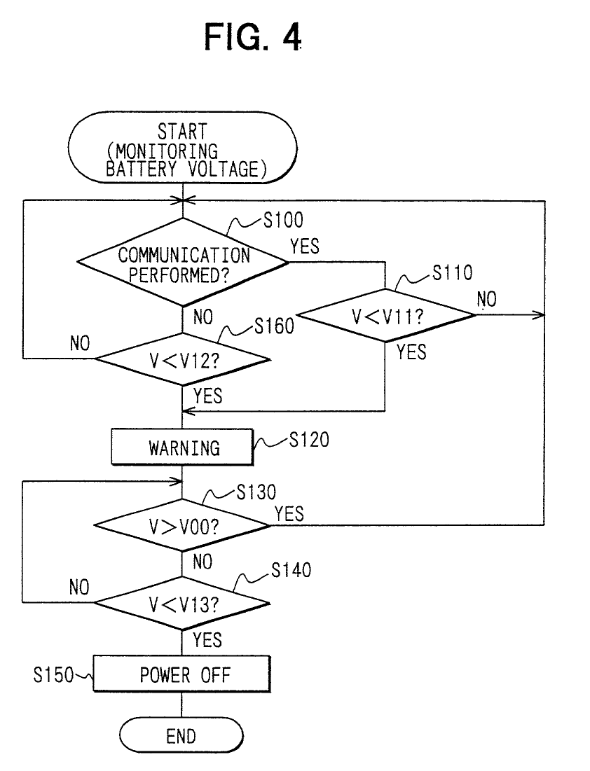

The controller 90 composed of a microcomputer and other components controls the music function and monitors the battery voltages among other things. Referring to the flowchart shown in FIG. 3, processing of the music function will be described. Upon starting power supply, the flag MQ indicating permission of operation of the music function and the flag MF indicating that the music function is activated are initialized and reset. Processing of the music function starts upon pushing a function key F18 on the keyboard 20 during a call waiting period. At step S200, whether the flag MQ is reset (MQ=0 indicates that operating the music function is permitted) is checked. If the music function is permitted (MQ=0), the process moves to step S210, where the flag MF is set (MF=1) to activate the music function. Then, the process moves to step S220 where music data stored in the memory 80 are read out. Then, the read out data are fed to the voice processor 50 at step S230, and the music sounds are output from the earphone 40c or the receiver 40b.

If the flag MQ is set to 1 at step S200 (the music function is not permitted), the process moves to step S240, where a warning that the music function is restricted is displayed on the display panel 30. This warning is displayed every time the function key F18 is pushed under this situation. Then, the process moves to step S250, where an inquiry to the user asking whether the user wants to operate the music function or not under this situation is displayed on the display panel 30. If the user selects to operate the music function by pushing a key “2”, the process moves to step S210. This means that the music function is operated by the user's choice even if the battery voltage is lower than V01 (explained later in detail). If the user selects not to operate the music function by pushing a key “1” at step S250, the music function is not operated, and the process proceeds to END. It is possible to eliminate step S250 to immediately prohibit the music function without inquiring the user's intention when the warning to restrict the music function is displayed at step S240.

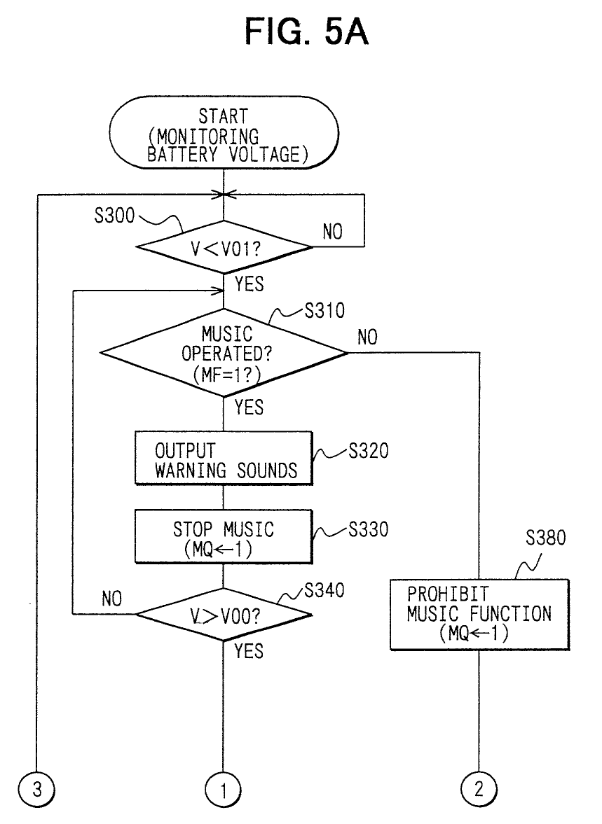

The warning to restrict the music function is displayed based on the battery voltage monitored. The battery voltage may be monitored in various ways. A process for monitoring the battery voltage is shown in FIG. 4 as a comparative example to the embodiment of the present invention. The battery voltage of the mobile phone having additional functions such as a music generating function in addition to the communication function may be monitored in the process shown in FIG. 4.

At step S100, whether telephone communication is being performed or not is checked. If the communication is being performed, the process proceeds to step S110. At step S110, whether the battery voltage V is lower than a first threshold voltage V11 (V<V11) is checked. The relative relation among various voltage levels described here is: V13<V12<V11<V00. If the battery voltage V is lower than V11, the process moves to step S120, where a warning indicating the battery voltage is not sufficiently high is displayed. Then, at step S130 it is confirmed whether the battery voltage V is higher than V00. If the battery voltage V is not higher than V00, the process proceeds to step S140. At step S140, whether the battery voltage V is lower than V13 is determined. If the battery voltage V is lower than V13, the process proceeds to step S150, where power supply to all the functions, i.e. the communication and additional functions is cutoff.

On the other hand, if the communication is not being performed (step S100), the process moves to step S160. At step S160, whether the battery voltage V is lower than a second threshold voltage V12 is determined. If the battery voltage V is lower than V12, the process proceeds to step S120 to display the warning. The steps following S120 are the same as those explained above.

In summary, the battery voltage warning is displayed when the battery voltage V becomes lower than a first threshold voltage V11 if the telephone communication is being performed. On the other hand, the warning is displayed when the battery voltage V becomes lower than the second threshold voltage V12 which is lower than the first threshold voltage V11 if the communication is not being performed. When the battery voltage becomes lower than V13 in either case, the power supply is cutoff to urge the user to recharge or replace the battery.

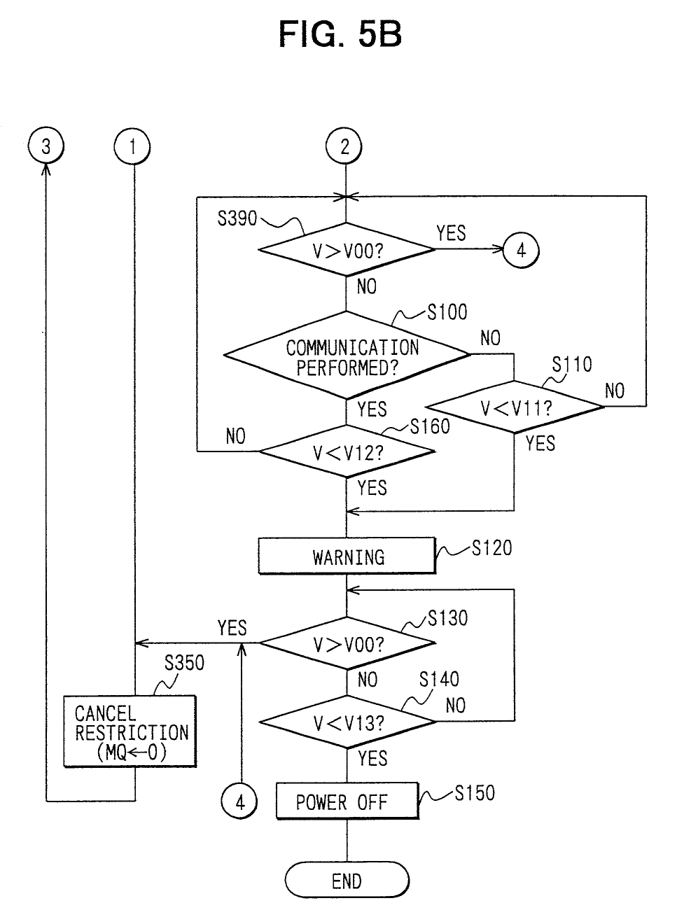

In the process described above, there may be a situation where the telephone communication is unexpectedly cut off if the user continues to operate the phone and/or the additional functions after the warning is displayed. This situation would occur more frequently if many additional functions are included in a mobile phone as in recent phones. To make a period of time in which the communication function is usable longer as possible and to make a mobile phone more user-friendly, the battery voltage monitoring process is improved as shown in FIGS. 5A and 5B as a embodiment according to the present invention.

The battery voltage monitoring process as an embodiment of the present invention will be described with reference to FIGS. 5A and 5B. In the following description, the relation among various voltage levels is: V13<V12<V11<V01<V00. A voltage V01 is another threshold voltage used in this embodiment as a third threshold voltage in addition to the first threshold voltage V11 and the second threshold voltage V12. The third threshold voltage V01 is a voltage level at which the music function is usable. At step S300, whether the battery voltage V is lower than V01 is determined. If the battery voltage V is lower than V01, the process proceeds to step S310. At step S310, whether the music function is operated (MF=1) is checked. If the music function is operated, the process moves to step S320, where warning sounds are superposed on the music sounds being played to output from the earphone 40c. The warning sounds may be a series of sounds, such as “Pi, Pi, Pi . . . .” Then, at step S330, the flag MQ is set to “1” to stop the music output the same to the earphone 40c. At step S340, whether the battery voltage V is higher than V00 is checked. If it is higher than V00, the process moves to step S350 (FIG. 5B), where the flag MQ is reset to “0” (MQ=0) to cancel the restriction of the music function. At this stage, the music function can be operated upon pushing the key F18.

If it is found that the music function is not operated (MF=0) at step S310, the process moves to step S380, where the flag MQ is set to “1” to prohibit operation of the music function. At this stage, the music function cannot be operated if the key F18 is pushed. Then, the process proceeds to step S390 (FIG. 5B). At step S390 whether the battery voltage V is higher than V00 is checked.

If it is higher than V00 (V>V00), the process moves to step S350. On the other hand, if the battery voltage V is lower than V00, the process moves to step S100. Steps S100 S160 are the same as those explained above with reference to FIG. 4.

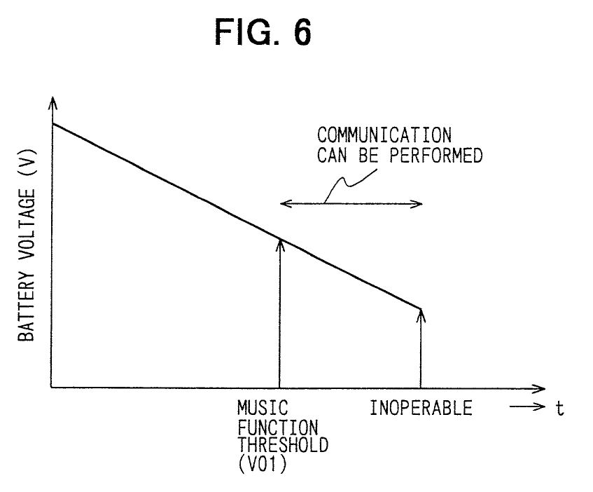

The third threshold voltage V01 which is higher than the first and the second threshold voltages (V01>V11>V12) is newly set in this embodiment to restrict the music function when the battery voltage is lowered to the level of V01. Therefore, the battery capacity is effectively saved for the communication function, compared with the comparative example described above with reference to FIG. 4. FIG. 6 illustrates a period of time during which the communication function is operable, after the battery voltage lowered to the level of the third threshold voltage V01 and the music function is restricted. In this manner, the period of time available for the communication function is prolonged. In addition, since the warning for the battery voltage decrease is given to a user by warning sounds superposed on the music being played, the user can easily recognize the battery voltage decrease while listening to the music.

The embodiment described above may be variously modified. For example, the battery voltage may be monitored by other methods than detecting its plus terminal voltage. Though the warning sounds indicating the battery voltage decrease are superposed on the music being played in the foregoing embodiment, it is possible to output the warning sounds from a speaker, such as a speaker for outputting a call-arrival melody. Further, it is possible to selectively change the levels of the third threshold voltage V01 by pushing keys on the keyboard 20. The functions of the mobile phone may be performed by means of a hardware in place of a computer software. Though the power supply is finally cutoff at step S150 in the foregoing embodiment, it is also possible to resume the power supply again by operating a key on the keyboard 20 to make the communication function operable until the battery capacity is used up.

Additional functions in the mobile phone are not limited to the music function but they may be other functions, such as a television function. Operation of those additional functions is similarly restricted or controlled. The communication function may include data communication in addition to the voice communication, but the data communication may be categorized in the additional function.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A mobile phone powered by a battery having a communication function and an additional function, the mobile phone comprising:
means for determining whether a level of a battery capacity is lower than a threshold level for permitting operation of the additional function;
means for detecting a signal indicating operation of the additional function; and
means for informing a user of restriction of the additional function when the battery capacity is lower than the threshold level and the signal indicating operation of the additional function exists.

2. The mobile phone as in claim 1, wherein:
the informing means includes means for inquiring user's intention whether to continue the operation of the additional function after the battery capacity becomes lower than the threshold level.

3. A mobile phone powered by a battery having a communication function and a function for producing music sounds, the mobile phone comprising:
means for determining whether a level of a battery capacity is lower than a threshold level for permitting operation of the music sounds producing function; and
means for terminating operation of the music sounds producing function and for informing a user of that effect when the battery capacity becomes lower than the threshold level during a period in which the music sounds generating function is being operated.

4. A mobile phone powered by a battery having a communication function and an additional function, the mobile phone comprising:
first means for determining whether a battery capacity is lower than a first level;
first means for restricting operation of the additional function when the battery capacity is lower than the first level;
second means for determining whether the battery capacity is lower than a second level which is lower than the first level; and
second means for restricting operation of the communication function when the battery capacity is lower than the second level.

5. The mobile phone as in claim 4, further including means for informing a user of restriction of the additional function when the battery capacity is lower than the first level.

6. The mobile phone as in claim 5, wherein:
the additional function is a function for producing music sounds.

7. The mobile phone as in claim 6, wherein:
the informing means informs the user of the restriction of the function for producing music sounds as warning sounds superposed on the music sounds.

8. The mobile phone as in claim 4, further including means for detecting whether the additional function is being operated, wherein:
the first restricting means terminates the operation of the additional function when the additional function is being operated.

9. The mobile phone as in claim 5, further including means for detecting whether the additional function is being operated, wherein:
the informing means includes a visual display panel for displaying the restriction of the additional function thereon; and
the restriction is displayed on the display panel as a sign to prohibit the operation of the additional function when the additional function is not being operated.

10. The mobile phone as in claim 9, further including means for selecting either to follow or not to follow the prohibiting sign displayed.

11. The mobile phone as in claim 4, further comprising:
third means for determining, after the first restricting means restricted the additional function, whether the battery capacity is higher than a third level which is higher than the first level; and
means for canceling the restriction of the additional function when the battery capacity is higher than the third level.

12. The mobile phone as in claim 4, wherein:
the first determining means and the second determining means determine the battery capacity based on a terminal voltage of the battery.

13. The mobile phone as in claim 11, wherein:
all of the first, second and third determining means determine the battery capacity based on a terminal voltage of the battery.

14. A mobile phone powered by a battery having a communication function and at least one additional function, the mobile phone comprising:
first means for determining whether a battery capacity is lower than a first level;
means for informing to a user that the battery capacity is lower than the first level when such is determined by the first determining means;
second means for determining whether the battery capacity is lower than a second level which is lower than the first level; and
means for restricting operation of the communication function when the battery capacity is determined to be lower than the second level by the second determining means.

15. The mobile phone as in claim 14, further comprising:
means for restricting operation of only the additional function when the battery capacity is determined to be lower than the first level by the first determining means.

16. The mobile phone as in claim 14, wherein:
the informing means further informs to the user that operation of only the additional function is restricted when the battery capacity is determined to be lower than the first level by the first determining means.
